(19) United States
(12) Patent Application Publication
(10) Pub. No.: US 2009/0059297 A1
(43) Pub. Date: Mar. 5, 2009

(54) CALIBRATION METHOD FOR IMAGE RENDERING DEVICE AND IMAGE RENDERING DEVICE

(75) Inventor: Hiroshi Uemura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/816,974

(22) PCT Filed: Feb. 24, 2006
(86) PCT No.: PCT/JP2006/304042

§ 371 Date: Aug. 23, 2007

(30) Foreign Application Priority Data
Feb. 24, 2005 (JP) 2005-049076

(51) Int. Cl. G06K 15/10

(52) U.S. Cl. 358/1.18

(57) ABSTRACT

A calibration method for an image rendering device is provided which calibrates offset in the direction around an optical axis of an alignment camera and enables improvement of the accuracy of correction of image rendering offset relative to an image rendering medium. A calibration reference mark is photographed by an alignment camera and the amount of rotation of the alignment camera around its optical axis is calculated using coordinate data for the calibration reference mark in the camera field of view. Based on the calculated data, the readings taken by the alignment camera during alignment are corrected.

### FIELD OF THE INVENTION

The present invention relates to a calibration method for an image rendering device and the image rendering method, in particular, to a calibration method for an exposure device and the exposure device.

### DESCRIPTION OF THE RELATED ART

Conventionally, in an exposure device which performs scanning and exposure on a photosensitive material such as a substrate, alignment (exposure position adjustment) is carried out prior to exposure in order to accurately adjust the exposure position in the X and Y direction to the photosensitive material. An exposure device uses an alignment camera such as a CCD camera to photograph an alignment mark, which is provided on the photosensitive material and serves as the exposure position standard. Alignment is performed by adjusting the exposure position to the correct position based on the mark measurement position (standard position data) obtained via this photographing. Since the exposure device is used to expose various types of photosensitive materials, all with different sizes and alignment mark positions, the alignment camera must be able to photograph even when the position of the alignment mark in the scanning direction and the direction perpendicular thereto changes. For example, an alignment camera, which is driven by a drive mechanism such as a ball screw and is guided by a device such as a guide rail extending along the direction (X direction) perpendicular to the scanning direction is described in Japanese Patent Application Laid-Open (JP-A) No. 8-222511. Such an alignment camera can be optionally moved to and arranged at any given position within the region of the X-direction dimension of the object to be exposed. Subsequently, the position of the alignment camera is detected and measured by a position detection unit such as a linear-scale unit, and this position is used as the standard for conducting the above-described alignment.

Further, in order to ensure the accuracy of this type of alignment function (exposure position adjustment function) calibration of each portion involved in alignment measurement is performed when the device is manufactured or maintenance is being performed thereon.

Various conventional technologies that relate to the calibration of alignment functions have been proposed for exposure devices using methods where an image is scan-exposed by irradiating a photosensitive material with a laser. The laser is irradiated while main-scanning the photosensitive material, which is moved in a sub-scanning direction.

An example of such a technique is described in JP-A No. 2000-329523. Predetermined processing in a processing unit is performed on a print circuit board set on a mounting table, and prior to this, calibration of the position of an alignment scope, which measures the print circuit board, is conducted as follows. A standard mark formed with a standard pattern is provided at the mounting table and after the alignment scope is moved to a preset position of the standard pattern, calibration of the alignment scope position is performed based on the amount of offset between the vertex of the standard pattern and the center of the alignment scope's field of vision.

However, in exposure devices employing a digital scan-exposure method or a scanning method using laser light for main scanning, there are cases during the alignment prior to exposure the alignment camera may rotate in a direction around an optical axis (θz rotation) and, further, when the alignment camera moves to a position for photographing the alignment mark, minor changes in this rotation occur due to flaws or the like in the accuracy of the parts constituting the camera drive mechanism or in the precision of assembly thereof.

Accordingly, the alignment mark and coordinates are photographed at a position that is offset from the original position by an amount corresponding to the rotation of the camera. Since the offset in the direction around the optical axis cannot be corrected simply by position calibration in the X and Y directions, errors can occur in the results of alignment measurement.

However, in the conventional technology, the influence of this kind of offset in the direction around the optical axis of the alignment camera has not been taken into account. As a result, even if alignment adjustment or calibration of the alignment function is carried out, offset in the direction around the optical axis is not corrected and, consequently, exposure offset cannot be accurately corrected.

### SUMMARY OF THE INVENTION

The present invention provides a calibration method for an image rendering device which, in an image rendering alignment function, enables calibration of offset in the direction around an optical axis of an alignment camera for photographing an alignment mark on an image rendering medium and enables the improvement of the accuracy of correction of image rendering offset relative to an image rendering medium. The present invention also provides an image rendering device in which the accuracy of correction of image rendering offset relative to an image rendering medium is improved.

A first aspect of the present invention is a calibration method for calibrating an image rendering alignment function of an image rendering device, wherein the image rendering device conducts image rendering alignment with respect to an image rendering medium based on standard position data obtained by reading image rendering position reference marks provided at the image rendering medium with a reading mechanism, and renders an image according to image data while moving the image rendering medium relative to a direction substantially parallel to an image rendering surface of the image rendering medium with a moving mechanism, and wherein, prior to the reading mechanism reading the image rendering position reference marks, an amount of rotary offset is detected, with respect to a detection measure, of the reading mechanism around an axis in a direction perpendicular to a surface substantially parallel to the image rendering surface of the image rendering medium, by reading at least one mark provided at the detection measure, which is a calibration reference plate.

According to the above aspect, the amount of rotary misalignment of the reading mechanism can be calibrated and the accuracy of correction of image rendering offset relative to the image rendering medium can be improved.

In the first aspect of the invention, the image rendering may be exposure in which a photosensitive material is exposed using a light beam modulated according to image data.

According to the above structure, the accuracy of correction of exposure offset relative to the photosensitive material can be improved.

In the first aspect of the invention, the amount of rotary offset of the reading mechanism may be corrected by a correction mechanism.

In addition, in the above aspect the correction mechanism may be a motor that rotates the reading mechanism in a direction of rotation having as its axis a direction perpendicular to a surface substantially parallel to an image rendering surface, and a drive force transmission mechanism.

According to the above structure, the amount of rotary offset of the reading mechanism is calibrated and the accuracy of correction of image rendering offset relative to the image rendering medium can be improved.

In the first aspect of the invention, the correction mechanism may correct the amount of rotary offset of the reading mechanism by correcting the standard position data read by the reading mechanism.

According to the above structure, image rendering alignment relative to the image rendering medium can be precisely performed.

A second aspect of the invention is a calibration method for an image rendering alignment function of an image rendering device, in which a calibration mark that is at least one of shape data and position data is recognized in advance by the image rendering device is read by an alignment camera, and an amount of rotation of the calibration mark around an axis in a direction perpendicular to the scanning surface from a predetermined position at the scanning surface with reference to the alignment camera is detected from image data of the read calibration mark, and rotation of the alignment camera around an optical axis with respect to a predetermined position is calibrated based on the results of the detection.

According to the above structure, rotation of the alignment camera around the optical axis is calibrated and the accuracy of correction of image rendering offset can be improved.

In the second aspect of the invention, the rotation of the alignment camera around the optical axis may be calibrated by calibrating coordinate data of an alignment mark obtained by the alignment camera.

According to the above structure, the accuracy of correction of image rendering offset can be improved.

In the second aspect of the invention, the alignment camera is movable in at least one direction, and the position of the alignment camera in at least one direction may be obtained by reading the calibration mark with the alignment camera.

Further, in the above aspect, position data for the alignment camera in at least one direction, and the amount of rotation of the calibration mark with respect to the alignment camera, can be obtained by using an alignment camera in the same position.

The accuracy of correction of image rendering offset can also be improved according to these structures.

A third aspect of the invention is a calibration method for an image rendering alignment function of an image rendering device that includes reading an calibration mark provided at an image rendering device using a reading mechanism; detecting an amount of rotary offset of the reading mechanism around an axis in a direction perpendicular to a surface substantially parallel to an image rendering surface of an image rendering medium, based on the result of the reading; and calibrating the image rendering alignment function based on the result of the detecting.

According to the above structure, the accuracy of correction of image rendering offset relative to the image rendering medium can be improved.

In the third aspect of the invention, calibration of the image rendering alignment function may be performed by correcting the reading mechanism.

According to the above structure, rotary offset of the reading mechanism is calibrated and the accuracy of correction of image rendering offset relative to the image rendering medium can be improved.

In the third aspect of the invention, calibration of the image rendering alignment function may be performed by correcting the reading results for an image rendering alignment mark as read by the reading mechanism.

According to the above structure, image rendering alignment relative to the image rendering medium can be performed extremely accurately.

In the third aspect of the invention, an amount of rotation of the calibration mark around an axis in the direction perpendicular to the surface substantially parallel to the image rendering surface of the image rendering medium with respect to a predetermined position may be detected from position data of the calibration mark that has been read, and the amount of rotary offset of the reading mechanism may be detected with respect to a predetermined position based on the result of the detection of the amount of rotation of the calibration mark.

Further, in the third aspect of the invention at least one of shape data of the calibration mark, and position data of the calibration mark with respect to the surface for image rendering of the image rendering medium, may be recognized by the image rendering device.

Rotary offset of the reading mechanism is calibrated and the accuracy of correction of image rendering offset relative to the image rendering medium can also be improved according to each of the above structures.

The fourth aspect of the invention is a calibration method for an image rendering alignment function of an image rendering device, wherein a calibration mark, for which at least one of shape data and position data relative to a scanning surface of the image rendering device is recognized in advance by the image rendering device, is read by an alignment camera; an amount of rotation of the calibration mark at the scanning surface around an axis in a direction perpendicular to the scanning surface is detected from data read by the alignment camera based on the at least one of shape data and position data recognized in advance; an amount of rotation of the alignment camera around an optical axis relative to a predetermined position is obtained based on the amount of rotation of the calibration mark detected; and calibration of the image rendering alignment function of the image rendering device is performed based on the amount of rotation of the alignment camera obtained.

According to the above structure, rotation of the alignment camera around its optical axis is calibrated and the accuracy of correction of image rendering offset can be improved.

In the fourth aspect of the invention, coordinate data for an alignment mark obtained by the alignment camera can be corrected based on the amount of rotation of the alignment camera around its optical axis that has been obtained.

According to the above structure, the accuracy of correction of image rendering offset can be improved.

A fifth aspect of the invention is an image rendering device having an image rendering alignment function which performs the image rendering alignment with respect to an image rendering medium based on a standard position data from the image rendering medium. The image rendering device includes a reading mechanism, a calibration reference portion, and a control portion, wherein the control portion retains calibration reference data from the calibration reference portion, calculates an amount of rotation of the reading device from a predetermined position around an axis in a direction perpendicular to a surface substantially parallel to an image rendering surface based on data from the calibration reference portion obtained by the reading mechanism and the calibration reference data, and calibrates the standard position data from the image rendering medium obtained by the reading mechanism based on the amount of rotation.

According to the above structure, the amount of rotation of the reading mechanism from a predetermined position around an axis in a direction perpendicular to the surface substantially parallel to the image rendering surface, can be calibrated extremely accurately, and the accuracy of correction of image rendering offset of the image rendering device can be improved.

In the above structure, the calibration reference data may be at least one of shape data from the calibration reference portion and position data from the calibration reference portion relative to the surface substantially parallel to the image rendering surface.

According to the present invention, it is possible to calibrate offset in a direction around the optical axis of a reading mechanism, the accuracy of calibration of the image rendering alignment function is improved, and the accuracy of correction of image rendering offset relative to the image rendering medium can be improved.

### BRIEF DESCRIPTION OF THE DRAWINGS

FIG. 1 is a perspective view showing an exposure device related to the calibration method of the present invention.

FIG. 2 is a perspective view showing an alignment unit related to the calibration method of the present invention.

FIG. 3 is a perspective view showing an alignment unit related to the calibration method of the present invention.

FIG. 4A shows a method of detecting an amount of rotation in a direction around an optical axis of an alignment camera, in the calibration method of the present invention.

FIG. 4B shows another method of detecting an amount of rotation in a direction around an optical axis of an alignment camera, in the calibration method of the present invention.

### DETAILED DESCRIPTION OF THE INVENTION

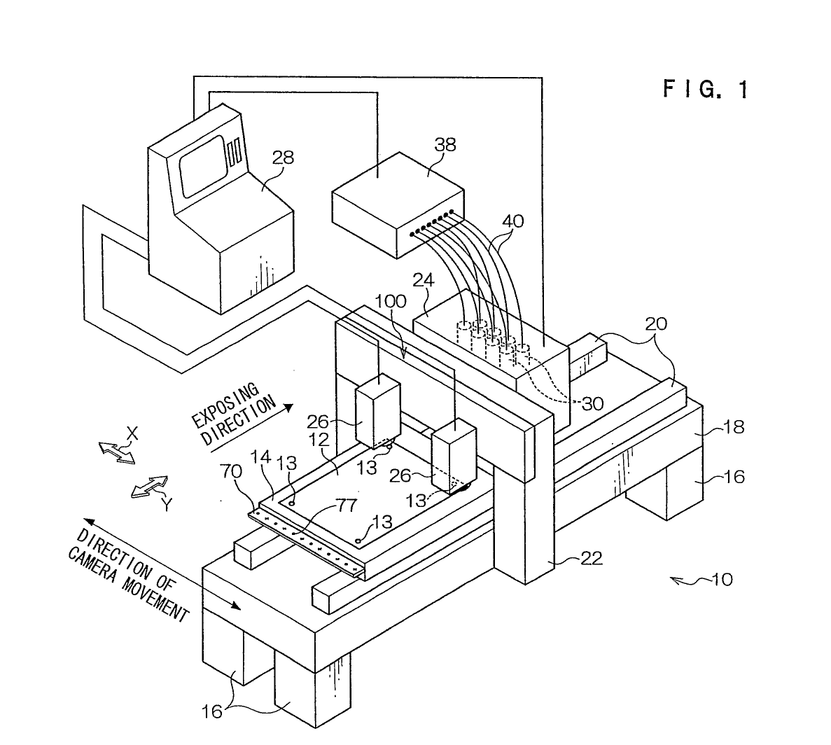

FIG. 1 shows an exposure device according to an embodiment of the present invention.

As shown in FIG. 1, an exposure device 10 is provided with a thick rectangular plate-shaped mounting board 18 supported by four legs 16. Two guides 20 are provided so as to extend in a longitudinal direction on the upper surface of the mounting board 18, and a rectangular board-shaped stage 14 is provided on the two guides 20. The stage 14 is disposed so that its longitudinal direction corresponds to the direction of extension of the guides 20, and is supported by the guides 20 such that it can move back and forth above the mounting board 18. The stage 14 is driven by a drive mechanism (not shown) and moves back and forth along the guides 20 in the direction of Arrow Y shown in FIG. 1.

A rectangular plate-shaped photosensitive material 12, which is the object to be exposed, is mounted at a predetermined position on the upper surface of the stage 14 in a set position state by a position setting portion (not shown). Multiple groove portions (not shown) are formed on the upper surface of the stage 14 (i.e., the photosensitive material mounting surface). The groove portions exhibit negative pressure due to a negative pressure supply source, whereby the photosensitive material 12 is suctioned to and retained on the upper surface of the stage 14. Further, the photosensitive material 12 is provided with multiple alignment marks 13 showing the standard position for exposure. In the present embodiment, a total of four alignment marks 13 composed of circular through-holes are each arranged in the vicinity of one of the four corners of the photosensitive material 12.

A U-shaped gate 22 is provided at the center portion of the mounting board 18 such that it straddles the path of movement of the stage 14. Each end portion of the gate 22 is fixed to a surface on either side of the mounting board 18. The gate 22 is sandwiched between, on one side, a scanner 24 that exposes the photosensitive material 12 and, on the other side, an alignment unit 100 provided with multiple (e.g., two) CCD cameras 26 for photographing the alignment marks 13 provided on the photosensitive material 12.

Further, a detection device which detects the position of irradiated beams and the amount of light thereof and which detects offset of the alignment function, is disposed downstream in an alignment measurement direction (upstream in the exposure direction) in the direction of movement (the direction of Arrow Y) of the stage 14. The detection device is provided with a reference plate 70 attached to the end edge portion of the stage 14 downstream in the alignment measurement direction, and a photo sensor (not shown) movably mounted at the reverse side of the reference plate 70. Calibration reference marks 77 are provided at the reference plate 70, and calibration of the alignment function is performed using the calibration reference marks 77 during manufacture or maintenance of the exposure device 10.

The alignment marks 13, which are provided at the photosensitive material and serve as a reference for the exposure position, are read by the CCD cameras 26. Prior to this, the exposure alignment function of the exposure device 10 is calibrated. The reference plate 70, which is provided with the calibration reference marks 77 arrayed at a predetermined interval along the direction of movement of the CCD cameras 26, is disposed at a position such that it can be read by the CCD cameras. At least one of the multiple calibration reference marks 77 is read by the CCD cameras disposed at a position where the alignment marks 13 are read and, based on the position data for the CCD cameras 26 obtained by this reading, an offset data of the calibration reference marks 77 around the imaging optical axis (the lens optical axis) is acquired and calibration data is calculated based on the acquisition, for example. The calibration data is then reflected in the standard position data from the alignment mark.

As a result, it becomes improved to calibrate the exposure alignment function, the accuracy of which is affected by positional variation factors accompanying the movement of the CCD cameras 26, and the accuracy of correction of exposure offset relative to the photosensitive material 12 can also be improved. Further, the position of the cameras can be precisely measured using the calibration reference marks whenever the cameras are moved.

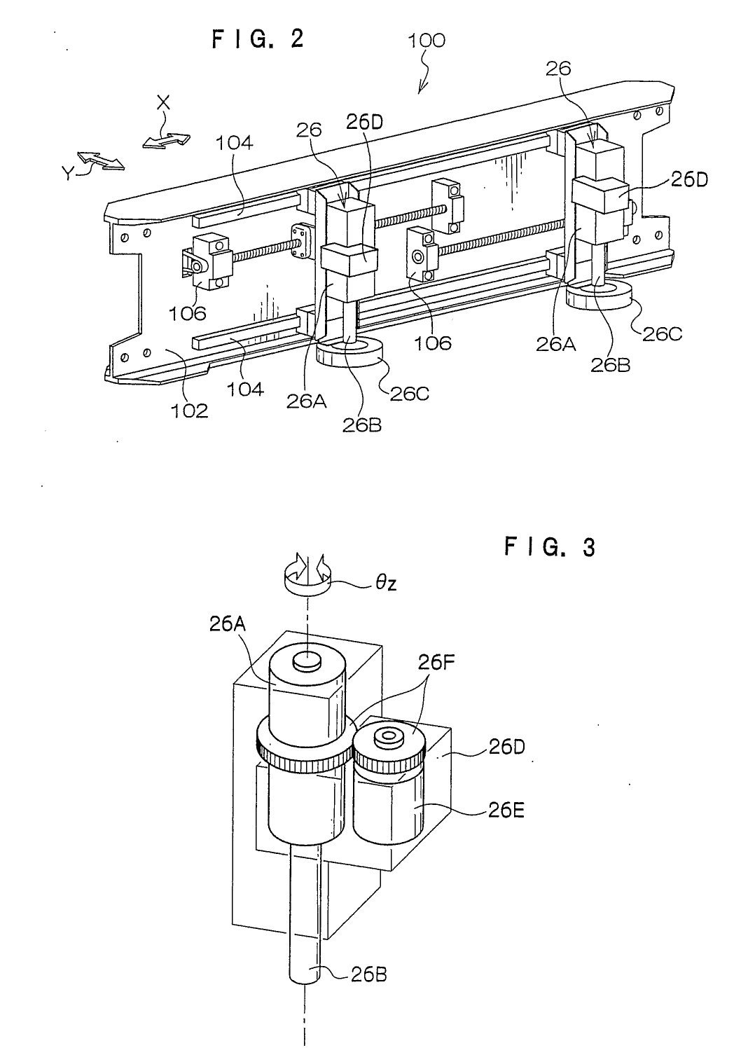

FIGS. 2 and 3 show an alignment unit according to a first embodiment of the present invention.

As shown in FIG. 2, the alignment unit 100 is provided with a rectangular unit base 102 that is attached to the gate 22. The surface of the unit base 102 at the side that houses the cameras also has a pair of guide rails 104 extending in a direction (the direction of Arrow X) orthogonal to the movement direction of the stage 14 (the direction of Arrow Y). Each CCD camera 26 is provided so as to be slidable along the pair of guide rails 14, and each CCD camera 26 is also individually provided with a ball screw mechanism 106 and a drive source such as a stepping motor (not shown) that drives the ball screw mechanism 106. The CCD cameras 26 thus independently move in a direction orthogonal to the movement direction of the stage 14. Further, each CCD camera 26 has a lens unit 26B attached to the end of a camera body 26A and facing downward. Each CCD camera is positioned so that the optical axis of the lens is substantially perpendicular to the X-direction, and a ring-shaped strobe light 26C (i.e., LED strobe light source) is attached to the end portion of the lens unit 26B.

The CCD cameras 26, when photographing the alignment marks 13 of the photosensitive material 12, are moved by the above-mentioned drive sources and ball screw mechanisms 106 in the direction of the Arrow X, and each is set at a preset photographing position. In other words, the lens optical axis is arranged to match the passing positions of the alignment marks 13 of the photosensitive material 12, which moves with the stage 14. Once the alignment marks 13 reach a predetermined photographing position, the strobe light 26C emits light at a fixed interval. The strobe light is irradiated on the photosensitive material 12 and the light that reflects off the upper surface of the photosensitive material 12 is inputted into the camera body 26A through the lens unit 26B, whereby the alignment mark 13 is photographed.

Further, as shown in FIG. 3, the CCD cameras 26 are respectively provided with rotary devices 26D and the degree of rotation (θz) around the optical axis (axis z) is adjustable. The rotary devices 26D are internally provided with motors 26E, and, as described later, based on data obtained by detecting the amount of rotation in the direction around the optical axis (θz rotation) of the CCD cameras 26, the amount of rotation in the direction around the optical axis is corrected. The motor 26E rotates the CCD camera 26 body thereby correcting the rotation of the CCD camera 26 around its optical axis.

Further, the drive device of the stage 14, the scanner 24, the CCD cameras 26, and the drive sources that move the CCD cameras 26 are all connected to a controller 28 that controls them. The controller 28 controls the stage 14 to move at a preset speed during the exposure operation of the exposure device 10 (described below). The CCD cameras 26, which are disposed at a predetermined position, are controlled so as to photograph the alignment marks 13 of the photosensitive material 12 with preset timing or continuously. The scanner 24 is controlled such that it exposes the photosensitive material 12 with preset timing.

When the exposure operation of the exposure device 10 begins, the drive device is controlled by the controller 28 and the stage 14, which has the photosensitive material 12 suctioned to its upper surface, begins moving in the moving direction (direction of Arrow Y) at a constant speed along the guides 20 from the upstream side to the downstream side in the alignment measuring direction. Each CCD camera 26 is controlled by the controller 28 to operate at a timing corresponding to the commencement of stage movement or slightly prior to the leading edge of the photosensitive material 12 arriving at a position directly below the CCD cameras 26. With the movement of the stage 14, alignment measurement is performed with the CCD cameras 26 as the photosensitive material 12 passes underneath the CCD cameras 26.

The alignment measurement first involves each CCD camera 26 photographing alignment marks 13 at preset timing. This is performed when two alignment marks 13 provided in the vicinity of the corners of the downstream side in the movement direction (the front edge side) of the photosensitive material 12 arrive directly beneath the respective CCD cameras 26 (on the optical axis of the lens). The photographed image data is outputted to the CPU, which is the data processing unit of the controller 28. The image data includes standard position data shown by the alignment marks 13 and indicates the standard exposure position. After the alignment marks 13 have been photographed, movement of the stage 14 in the downstream direction recommences.

Moreover, in cases where, as with the photosensitive material 12 of the present embodiment, the photosensitive material 12 has multiple alignment marks 13 provided along the movement direction (scanning direction), when the next alignment marks 13 (i.e., the two alignment marks 13 provided in the vicinity of the corners upstream in the movement direction, that is, at the rear edge side) arrive directly beneath each CCD camera 26, each CCD camera 26 photographs the respective alignment mark 13 at a preset timing and outputs the image data to the CPU of the controller 28, similar to the above-described process.

The CPU processes calculations based on the mark positions and the pitch between the marks ascertained within an image from the inputted image data for each alignment mark 13 (standard position data), as well as on the position of the stage 14 at the time of photographing the alignment marks 13 in question and the position of the CCD cameras 26. From these calculations, the CPU ascertains, for example, deviations in the mounting position of the photosensitive material 12 on the stage 14, deviations of the photosensitive material 12 relative to the movement direction, and dimensional accuracy errors in the photosensitive material 12, and calculates the correct exposure position relative to the surface of the photosensitive material 12 to be exposed. Next, when image exposure is performed with the scanner 24, a control signal is generated based on the image data of the exposure pattern stored in the memory (not shown), the control signal having the correct exposure position adjusted and incorporated therein, whereby correction control (alignment) for image exposure is executed.

When the photosensitive material 12 passes underneath the CCD cameras 26 and alignment measurement with the CCD cameras 26 is completed, the stage 14 is then driven by the drive device in the opposite direction, thus moving along the guides 20 in the exposure direction. With the movement of the stage 14, the photosensitive material 12 moves underneath the scanner 24 and downstream in the exposure direction. Once the image exposure regions of the surface to be exposed arrive at an exposure commencement position, each exposure head 30 of the scanner 24 irradiates beams of light, thus beginning image exposure of the surface of the photosensitive material 12 to be exposed.

In the exposure device 10 of the present embodiment, variations in the positioning (rolling, pitching, and yawing) of the CCD cameras 26 are caused by movement of the CCD cameras 26, and there are cases where the center of the optical axis of the photographing lens, when disposed at a photographing position, deviates from the normal position. Consequently, even if image exposure is performed when the exposure position has been corrected using the alignment function, deviation of the exposure position from the proper position can exceed allowable limits.

In order to correct the defects in the alignment function due to positioning variations of the CCD cameras 26, correction of the alignment function is executed using the calibration reference marks 77 provided at the reference plate 70 when, for example, the exposure device 10 is being manufactured or undergoing maintenance.

However, offset in the direction around the optical axis of the alignment camera cannot be eliminated even when the above correction is conducted. In other words, shift around the optical axis of the CCD cameras 26 (rotation) is different from the variations in positioning (rolling, pitching, and yawing) that accompany movement of the CCD cameras 26, and since calibration cannot be achieved by the above correction, the coordinates of the alignment marks 13 deviate from their original positions to the extent that the CCD cameras 26 have rotated around their optical axes.

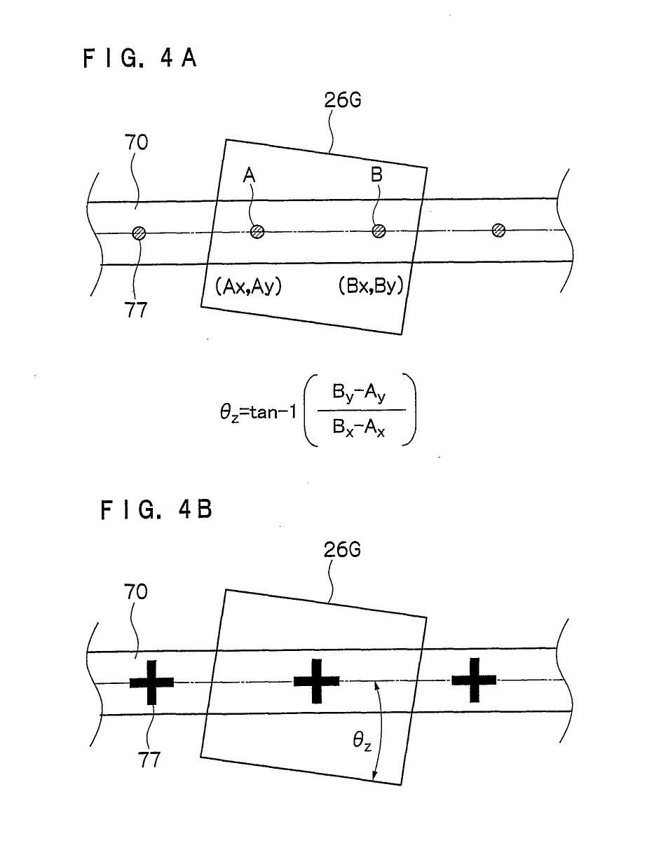

Consequently, as shown in FIGS. 4A and 4B, in the first embodiment of the present invention, accurate calibration is performed by detecting the amount of rotation (θz) in the direction around the optical axis.

FIGS. 4A and 4B illustrate a method for detecting the amount of rotation of the alignment camera according to the first embodiment of the present invention.

As shown in FIG. 4A, after the CCD cameras 26 have been moved to positions (in the X direction) for reading the alignment marks 13 as described above, the CCD cameras 26 photograph the multiple calibration reference marks 77 within the camera fields of view 26G. This process may be performed at the same time as photographing for position measurement in the X direction.

When the photographed calibration reference marks 77 are taken to be A and B, the CCD camera 26 photographs A and B within the camera field of view and outputs the image data to the CPU of the controller 28. The CPU obtains X-coordinate data and Y-coordinate data based on the camera field of view 26G from the input image data of the calibration reference marks 77 (A and B). When the coordinate data thus obtained are taken to be (Ax, Ay) and (Bx, By), the amount of rotation (θz) of the CCD camera 26 in the direction around the optical axis is calculated by the following formula.

θz=tan⁻¹((By−Ay)/(Bx−Ax))

Based on the value for θz calculated by the above method, the motor 26E shown in FIG. 3 is driven and an adjustment to correct θz is carried out. As a result, it is possible to accurately perform calibration of misalignment of the CCD camera 26 in the direction around the optical axis.

Further, instead of rotating the CCD cameras using the rotary devices 26D of FIG. 3, θz may be corrected via a software-based approach by conducting an adjustment to correct the image data of the alignment marks within the field of vision of the CCD cameras using the data for variations in θz when performing alignment. In addition, both of the above methods may be used in combination.

Further, θz may be calculated by photographing only one calibration reference mark 77, as shown in FIG. 4B. In other words, θz is calculated by image processing when the shape of the calibration reference marks is made to be a shape other than circular such that it is a mark that is asymmetrical in the direction of rotation.

Specifically, calibration of rotation of the CCD cameras 26 in the direction around the optical axis can be carried out in the same way as the above method by providing the calibration reference marks 77 with a straight line portion extending in the X direction (or the Y direction) as shown in FIG. 4B, and taking θz as the angle formed between the straight line portion and the X direction (or the Y direction) of the camera field of view 26G. Since this method allows for calculation of θz by photographing one calibration reference mark 77, in terms of measurement accuracy, while this method may be behind to the method of photographing multiple calibration reference marks 77, a greater degree of freedom can be achieved for the point of measurement.

The above embodiment of the present invention provides an example of an exposure device that performs exposure with respect to a photosensitive device; however, the present invention is not limited to this and can, for example, be used in an image rendering device that renders images using an inkjet recording head or the like.

### INDUSTRIAL APPLICABILITY

As explained above, according to the present invention, the accuracy of calibration of the image rendering alignment function of an image rendering device is improved, and the accuracy of correction of deviation in image rendering position with respect to an object to be subject to image rendering can be improved. The present invention is particularly useful as a calibration method for an exposure device.

1. A calibration method for calibrating an image rendering alignment function of an image rendering device, wherein the image rendering device conducts image rendering alignment with respect to an image rendering medium based on standard position data obtained by reading image rendering position reference marks provided at the image rendering medium with a reading mechanism, and renders an image according to image data while moving the image rendering medium relative to a direction substantially parallel to an image rendering surface of the image rendering medium with a moving mechanism, and wherein
prior to the reading mechanism reading the image rendering position reference marks, an amount of rotary offset, with respect to a detection measure, of the reading mechanism around an axis in a direction perpendicular to a surface substantially parallel to the image rendering surface of the image rendering medium, is detected by reading at least one mark provided at the detection measure, which is a calibration reference plate.

2. The calibration method for calibrating an image rendering alignment function of an image rendering device according to claim 1, wherein the image rendering is performed by conducting exposure on a photosensitive material using a light beam modulated according to the image data.

3. The calibration method for calibrating an image rendering alignment function of an image rendering device according to claim 1, wherein at the time of the calibration, the amount of rotary offset of the reading mechanism is corrected with a correction mechanism.

4. The calibration method for an image rendering alignment function of an image rendering device according to claim 3, wherein the correction mechanism comprises a motor that rotates the reading mechanism in a direction of rotation around the axis in the direction perpendicular to the surface substantially parallel to the image rendering surface of the image rendering medium, and a driving force transmission mechanism.

5. The calibration method for an image rendering alignment function of an image rendering device according to claim 3, wherein the correction mechanism corrects the amount of rotary offset by correcting the standard position data read by the reading mechanism.

6. A calibration method for an image rendering alignment function of an image rendering device, comprising:
a calibration mark that is at least one of shape data and position data is recognized in advance by the image rendering device is read by an alignment camera;
an amount of rotation of the calibration mark around an axis in a direction perpendicular to the scanning surface from a predetermined position at the scanning surface with reference to the alignment camera is detected from image data from the read calibration mark; and
rotation of the alignment camera around an optical axis with respect to a predetermined position is calibrated based on the results of the detection.

7. The calibration method for an image rendering alignment function of an image rendering device according to claim 6, wherein the rotation around the optical axis of the alignment camera is calibrated by calibrating coordinate data of an alignment mark obtained by the alignment camera.

8. The calibration method for an image rendering alignment function of an image rendering device according to claim 6, wherein the alignment camera is movable in at least one direction, and position data is obtained for the alignment camera in the at least one direction by reading the calibration mark with the alignment camera.

9. The calibration method for an image rendering alignment function of an image rendering device according to claim 8, wherein the position data for the alignment camera in the at least one direction, and the amount of rotation of the calibration mark with reference to the alignment camera, are obtained using the alignment camera in the same position.

10. A calibration method for an image rendering alignment function of an image rendering device, comprising:
reading an calibration mark provided at an image rendering device using a reading mechanism;
detecting an amount of rotary offset of the reading mechanism around an axis in a direction perpendicular to a surface substantially parallel to an image rendering surface of an image rendering medium, based on the result of the reading; and
calibrating the image rendering alignment function based on the result of the detecting.

11. The calibration method for an image rendering alignment function of an image rendering device according to claim 10, wherein the calibrating of the image rendering alignment function is carried out by correcting the reading mechanism.

12. The calibration method for an image rendering alignment function of an image rendering device according to claim 10, wherein the calibrating of the image rendering alignment function is carried out by correcting the result of the reading of an image rendering alignment mark by the reading mechanism.

13. The calibration method for an image rendering alignment function of an image rendering device according to claim 10, wherein an amount of rotation of the calibration mark around an axis in the direction perpendicular to the surface substantially parallel to the image rendering surface of the image rendering medium with respect to a predetermined position is detected from position data of the calibration mark that has been read, and the amount of rotary offset of the reading mechanism is detected with respect to a predetermined position based on the result of the detection of the amount of rotation of the calibration mark.

14. The calibration method for an image rendering alignment function of an image rendering device according to claim 10, wherein at least one of shape data of the calibration mark, and position data of the calibration mark with respect to the surface substantially parallel to the surface for image rendering of the image rendering medium, are recognized by the image rendering device.

15. A calibration method for an image rendering alignment function of an image rendering device comprising:
a calibration mark, for which at least one of shape data and position data relative to a scanning surface of the image rendering device is recognized in advance by the image rendering device, is read by an alignment camera;
an amount of rotation of the calibration mark at the scanning surface around an axis in a direction perpendicular to the scanning surface is detected from data read by the alignment camera based on the at least one of shape data and position data recognized in advance;
an amount of rotation of the alignment camera around an optical axis relative to a predetermined position is obtained based on the amount of rotation of the calibration mark detected; and
calibration of the image rendering alignment function of the image rendering device is performed based on the amount of rotation of the alignment camera obtained.

16. The calibration method for an image rendering alignment function of an image rendering device according to claim 15, wherein coordinate data for an alignment mark obtained by the alignment camera is corrected based on the amount of rotation of the alignment camera around the optical axis obtained.

17. The calibration method for an image rendering alignment function of an image rendering device according to claim 15, wherein the alignment camera is movable in at least one direction and position data for the alignment camera in the at least one direction is obtained by reading the calibration mark with the alignment camera.

18. An image rendering device having an image rendering alignment function, wherein the image rendering alignment is performed with respect to an image rendering medium based on a standard position data from the image rendering medium comprising:
a reading mechanism;
a calibration reference portion; and
a control portion; wherein
the control portion retains calibration reference data from the calibration reference portion, calculates an amount of rotation of the reading device from a predetermined position around an axis in a direction perpendicular to a surface substantially parallel to an image rendering surface based on data from the calibration reference portion obtained by the reading mechanism and the calibration reference data, and calibrates the standard position data from the image rendering medium obtained by the reading mechanism based on the amount of rotation.

19. The image rendering device according to claim 18, wherein the calibration reference data is at least one of shape data from the calibration reference portion and position data from the calibration reference portion relative to the surface substantially parallel to the image rendering surface.
